(19) United States
(12) Patent Application Publication
(10) Pub. No.: US 2016/0338320 A1
(43) Pub. Date: Nov. 24, 2016

(54) Cat Scratcher Kit

(71) Applicant: Worldwise, Inc., San Rafael, CA (US)

(72) Inventors: Charles Floyd, Oakland, CA (US); Sara Paculdo, Novato, CA (US); Aimee Diskin, Napa, CA (US)

(21) Appl. No.: 14/720,762

(22) Filed: May 23, 2015

(51) Int. Cl. A01K 15/02

(52) U.S. Cl. CPC A01K 15/024

(57) ABSTRACT

A kit for providing a scratcher for use by a pet cat. The kit includes a plurality of scratching elements, each scratching element having top and bottom scratching surfaces and peripheral edges. Each scratching element is a cardboard body in which open corrugations are exposed by both of the top and bottom surfaces. The peripheral edges include connective elements for connecting the plurality of scratching elements to one another.

### TECHNICAL FIELD

The present invention involves a kit for providing a scratcher for use by a pet cat in satisfying its inherent desire to scratch. The kit includes replaceable scratching elements to extend the life of the kit and to enable a pet owner to customize the shape and positioning of the scratcher as desired.

### BACKGROUND OF THE INVENTION

It is well recognized that domestic cats crave scratching as part of their natural instinctive character. If a dedicated scratching surface is not provided, domestic cats would generally satisfy their need to scratch by turning to furniture, curtains and other articles which can be substantially damaged as a consequence. Often times, pet cats will not only climb over furniture, specifically upholster chairs and sofas, but will use such furniture and carpeting to condition their claws through deliberate repeated clawing, pulling and tearing actions specifically with their forepaws. As noted, this clawing activity appears to be an irresistible natural impulse for cats and can be the source of great aggravation to the pet owner.

There are a number of vendors of pet and pet related products that have offered implements dedicated to alleviating the need of a cat to scratch. These include cat scratching posts and pads comprised of, for example, carpet, sisal, seagrass, rope and cardboard. In most instances, the cat scratching surface is either permanently affixed to a support or, in the case of a pad, is purchased with a fixed geometry assuming that most pet owners would find them to meet their basic needs. If the pet owner had a unique situation, such as if his or her pet constantly gravitated to the same area to scratch, commercially available scratchers may not lend themselves to meet the pet's unique preferences and thus the scratcher may not solve the basic problem of diverting the cat's attention from using furniture, drapes and the like as its preferred scratching surfaces.

It has also been observed that a favored scratcher is one composed of cardboard. When the cardboard's open corrugations are exposed, they constitute an inviting scratching surface as the cat can embed its claws within them noting further that cardboard is relatively soft and will abrade if the cat was to catch a claw on its corrugations. The open corrugations also provide convenient interstices for the receipt of catnip which is oftentimes used to further encourage the cat to engage the scratcher. However, the nature of cardboard which makes it an excellent scratcher also results in a lack of durability such that the scratcher is subject to degradation and eventual disposal much more frequently than would be the case with other surfaces.

It is thus an object of the present invention to provide a cardboard-based scratcher which can be configured into diverse geometrical shapes to suit the needs of a pet owner. It is a further object to the present invention to provide a cardboard-based scratcher having a plurality of subparts, some of which can be individually replaced without the need to replace other subparts which do not require replacement.

These and further objects will be readily apparent when considering the following disclosure and appended claims.

### SUMMARY OF THE INVENTION

A kit for providing a scratcher for use by a pet cat, said kit comprising a plurality of scratching elements, each scratching element having top and bottom scratching surfaces and peripheral edges, each scratching element comprising a cardboard body in which open corrugations are exposed by both of said top and bottom surfaces and at least one of said peripheral edges comprising a connective element for connecting a scratching element to an adjacent scratching element.

A kit for providing a scratcher for use by a pet cat, said kit comprising catnip, double sided foam adhesive tape and a plurality of scratching elements, each scratching element having top and bottom scratching surfaces and peripheral edges, each scratching element comprising a cardboard body in which open corrugations are exposed by both of said top and bottom surfaces and at least one of said peripheral edges comprising said double sided foam adhesive tape for connecting a scratching element to an adjacent scratching element.

A method of constructing a scratcher for use by a pet cat, said method comprising providing a source of catnip, double sided foam adhesive tape and a plurality of scratching elements, each scratching element having top and bottom scratching surfaces and peripheral edges, each scratching element comprising a cardboard body in which open corrugations are exposed by both of said top and bottom surfaces, applying said double sided foam adhesive tape to at least one of said peripheral edges, joining two of said scratching elements to one another by joining adjacent peripheral edges by said double sided foam adhesive tape and adding said catnip to at least some of said open corrugations.

### BRIEF DESCRIPTION OF THE FIGURES

FIG. 1 is a perspective view of a scratching element made part of the kit of the present invention.

FIG. 2 is a cross-sectional view taken along line 2-2 of FIG. 1.

FIGS. 3A and 3B depict typical installations where the kit of the present invention can be employed.

FIG. 4 is a plan view of a catnip pouch constituting a component of the kit of the present invention.

FIG. 5 is a top view of a roll of double-sided foam adhesive tape constituting a component of the kit of the present invention.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

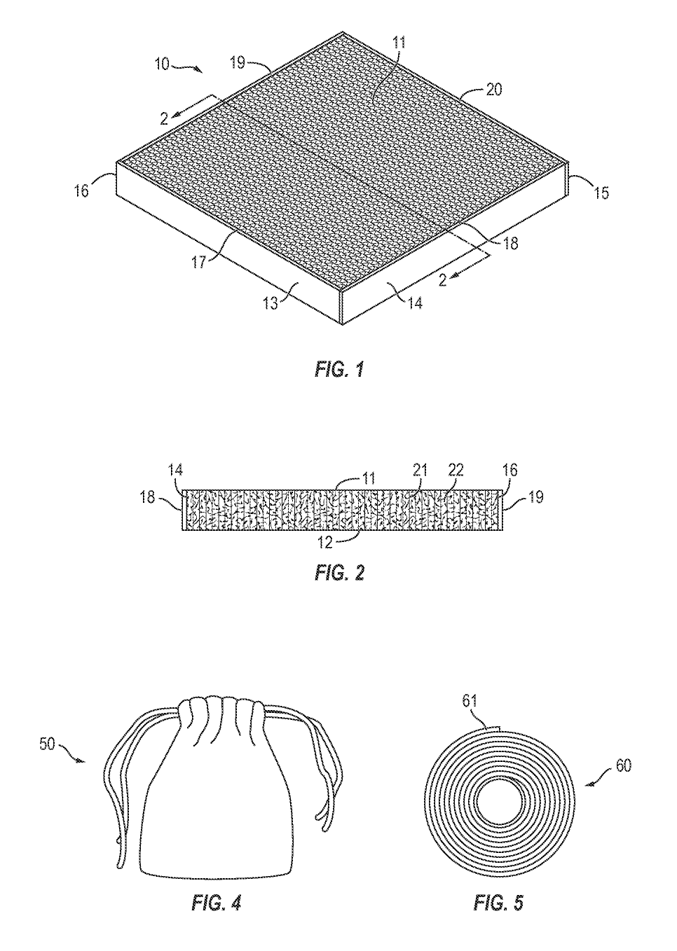

The present invention is directed to a kit for providing a scratcher for use by a pet cat. In turning to FIG. 1, scratching element 10 is illustrated as constituting one of a plurality of such elements as components of the kit.

Scratching element 10 is characterized as having top and bottom scratching surfaces 11 and 12 and peripheral edges 13, 14, 15 and 16. Scratching element 10 comprises a cardboard body in which open corrugations 21 are exposed by both top and bottom surfaces 11 and 12. As the pet owner desires, open corrugations 21 can be used to receive catnip flakes 22 sprinkled from pouch 50 in order to further engage one's pet and encourage use of scratching element 10 to the exclusion of upholster furniture, drapes and the like.

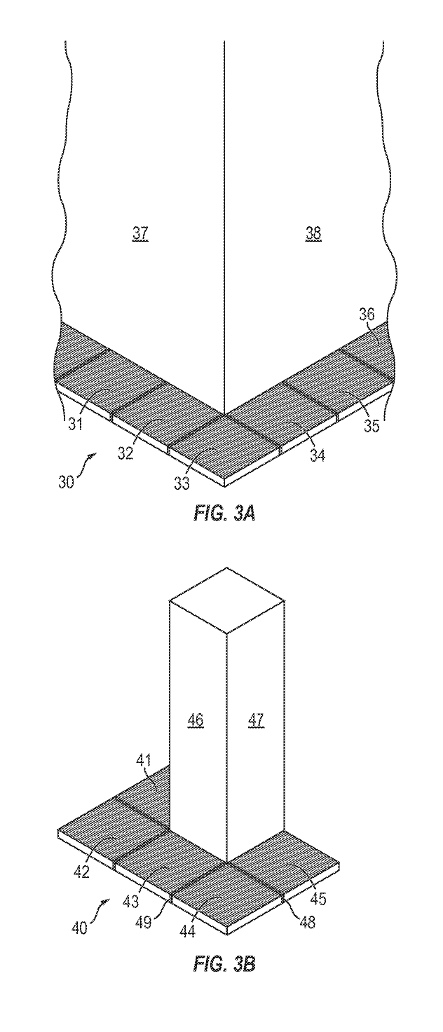

Ideally, scratching elements 10 are square or rectangular although other shapes can be employed while remaining within the spirit and scope of the present invention. A significant advantage in employing the present kit is to enable scratchers to be installed and employed in different physical environments dictated by one's room configuration for placement in areas where it is been observed that a cat likes to carry on its scratching activity. In this regard, reference is made to FIGS. 3A and 3B.

In turning first to FIG. 3A, an interior corner of one's room defined by orthogonally joined walls 37 and 38 is depicted. Knowing that one's pet has used the area as a favored scratching region, individual scratching elements 31, 32, 33, 34, 35 and 36 are placed on the floor about the joinder of walls 37 and 38 constituting multi-unit scratcher 30. Similarly, FIG. 3B depicts a post having vertically extending walls 46 and 47 such that multi-unit scratcher 40 is applied to its base composed of individual scratching elements 41, 42, 43, 44 and 45. Individual scratching elements can be joined to one another along their peripheral edges by providing double sided foam adhesive tape in strips 17, 18, 19 and 20. Strips joining adjacent scratching elements can be cut from double-sided foam adhesive tape 61 paid out from roll 60, also contained within the present kit. As noted, double-sided foam adhesive tape 61 is shown applied to scratching element 10 (FIG. 1) as segments 17, 18, 19 and 20. In use, double-sided foam adhesive tape 61 would be applied to the peripheral edges of those individual scratching elements intended to join adjacent scratching elements. For example, in turning to FIG. 3B, double-sided foam adhesive tape 48 and 49 would be applied to scratching element 44 where scratching element 44 abuts scratching element 43 and scratching element 45. Once having done so, the individual scratching elements constitute a scratching surface appropriate for use by one's pet.

As noted previously, as the scratching elements of the present invention are composed of cardboard, they tend to degrade quicker than other commonly used scratching surfaces and, as a preferred embodiment, the present invention contemplates the ability to replace individual scratching elements without replacing the entire multi-unit scratcher as needed. For example, in turning again to FIG. 3A, if scratching element 33 being located at the corner of walls 37 and 38 is degraded faster than the other scratching elements within the kit, it would clearly be desirable to be able to replace scratching element 33 without replacing the other scratching elements which have not been sufficiently degraded to require replacement. The present invention contemplates this by using connectors such as double-sided foam adhesive tape 61 which facilitates releasable detachment of adjacent peripheral edges. Thus, one can simply remove element 33 by pulling it away from elements 32 and 34 and replacing it with a new scratching element thus refreshing the scratcher, generally.

In summary, the present invention provides a kit in the form of individual scratching elements enabling one to provide a scratching surface in virtually any location within one's residence and also provides a cost-effective means to replace a portion of the scratching surface once degraded.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A kit for providing a scratcher for use by a pet cat, said kit comprising a plurality of scratching elements, each scratching element having top and bottom scratching surfaces and peripheral edges, each scratching element comprising a cardboard body in which open corrugations are exposed by both of said top and bottom surfaces and at least one of said peripheral edges comprising a connective element for connecting a scratching element to an adjacent scratching element .

2. The kit of claim 1 wherein each of said scratching elements are square or rectangular.

3. The kit of claim 1 further comprising catnip contained within at least some of said open corrugations.

4. The kit of claim 1 wherein said at least one of said connective elements comprises double sided foam adhesive tape.

5. A kit for providing a scratcher for use by a pet cat, said kit comprising catnip, double sided foam adhesive tape and a plurality of scratching elements, each scratching element having top and bottom scratching surfaces and peripheral edges, each scratching element comprising a cardboard body in which open corrugations are exposed by both of said top and bottom surfaces and at least one of said peripheral edges comprising said double sided foam adhesive tape for connecting a scratching element to an adjacent scratching element.

6. A method of constructing a scratcher for use by a pet cat, said method comprising providing a kit having a source of catnip, double sided foam adhesive tape and a plurality of scratching elements, each scratching element having top and bottom scratching surfaces and peripheral edges, each scratching element comprising a cardboard body in which open corrugations are exposed by both of said top and bottom surfaces, applying said double sided foam adhesive tape to at least one of said peripheral edges, joining two of said scratching elements to one another by joining adjacent peripheral edges by said double sided foam adhesive tape and adding said catnip to at least some of said open corrugations.
